(19) United States
(12) Patent Application Publication
(10) Pub. No.: US 2006/0109516 A1
(43) Pub. Date: May 25, 2006

(54) Personal photo book creation kit

(76) Inventors: Rodrigo Catalan, Pacific Palisades, CA (US); David Gustin, Irvine, CA (US)

Correspondence Address: PILLSBURY WINTHROP SHAW PITTMAN LLP, P.O BOX 10500, McLean, VA, 22102, US

(21) Appl. No.: 10/995,651

(22) Filed: Nov. 23, 2004

(51) Int. Cl. H04N 1/23

(52) U.S. Cl. 358/302

(57) ABSTRACT

The present invention relates to a kit and method for creating a personal photo book on a home computer. The kit includes software, photo pages, extra-long photo pages to make a cover for the book and a hard-bound book. The photo pages are secured in the hard-bound book by squaring page layout templates that have been printed on the photo pages with the attachment pages secured within the hard-bound book. The printed page layout templates are then secured to the hard-bound book by the use of an adhesive located on the attachment page. The majority of the attachment page may then be removed by use of a perforation on the attachment page.

### BACKGROUND

Digital cameras are continuing to rise in popularity. One of the popular features of digital cameras is the ability of a user to download the pictures from the digital camera to a computer and to immediately share the photos with family and friends either through the internet or by printing them out on a home printer. Some personal printers have the ability to render photographic quality prints of the digital pictures, especially if the digital photos are printed on photographic-quality printer paper. Thus, prints of digital photographs can be made on a user's computer that rival those of photos made from film-based cameras.

With the rise of digital cameras, some vendors have started offering professional-looking photo albums and books that can be ordered over the internet that contain the user's digital photos. The user sends the digital photos they would like to be portrayed in the album and the vendor then arranges them in a template layout fashion, prints the photos on photo paper and binds them into a professional looking book. Such photo albums and books can rival those albums and books typically produced by professionals using film, such as wedding photographers.

However, two of the features that have spurred the popularity of digital cameras are the control the user has over the photos, and the immediacy with which the user can share the photos with friends and family. Both of these features are diminished when using the professional services mentioned above. When a user sends the photos off to an album service, the user loses some of the control that he had. For instance, the user is not normally given a choice about which picture will go onto a certain layout page. Thus, layout pages that contain multiple pictures may have pictures that do not necessarily fit together in a cohesive fashion. A picture that is from one's trip to Italy likely does not belong on the same page as a picture from one's family reunion. Additionally, the user will have to wait for the professional service to finish making the album and for the professional service to ship the album to the user before the user can share the album. Thus, what is needed is a product that will allow a user to create professionally looking photo books on a user's own computer without having to resort to an outside company to produce the album.

### SUMMARY OF THE INVENTION

The present invention is directed to a kit and method that will allow a user to produce professional-looking photo albums on a home computer, preferably using a photo-quality printer. The kit includes software that will allow a user to manipulate digital photographs, such as fix red eye, sharpen images, change the brightness and contrast of the photos. The software also includes a series of professional layout templates patterned after ones that one would likely see in a professionally produced photo album or book, such as a professionally produced wedding album. Using the software, the user can place and replace images into the templates according to his liking. Additionally, a user may also be able to use a template to produce a cover/dust jacket for the hard-bound book. The software may also include other features such as the ability preview the final album pages before printing (print preview) and print drafts of the layout pages.

The kit may also include photo paper for printing the layout templates with pictures. At least one of the photo papers may be an oversized photo paper that may be used to print a cover for the photo album.

The kit may also include a hard-bound book in which to place the printed layout templates. The hard-bound book may be filled with a plurality of attachment sheets. The attachment sheets may have a thin strip of adhesive, preferably covered with a release liner to prevent attachment pages from sticking together. The attachment pages preferably also have a perforation running vertically from the top of the pages to the bottom at a location near the adhesive strip. Once a printed layout template has been secured to an attachment page via the adhesive strip, the rest of the attachment page may be detached by tearing it along the perforation.

### BRIEF DESCRIPTION OF THE DRAWINGS

FIG. 1 depicts elements of a kit for creating a personal photo book according to an embodiment of the present invention;

FIG. 2 illustrates a creation of printed page layout templates and printed cover page layout templates for placement in a personal photo book according to an embodiment of the present invention.

FIG. 3 illustrates a creation of a personal photo book according to an embodiment of the present invention.

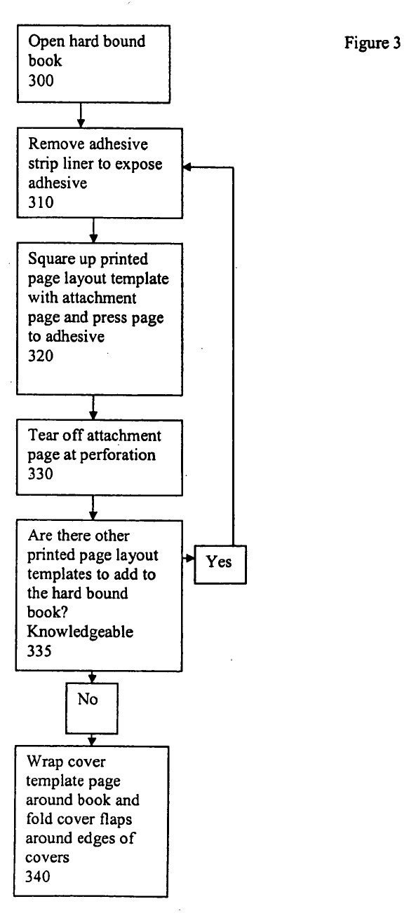

FIG. 4 illustrates a screen of a graphical user interface according to an embodiment of the present invention.

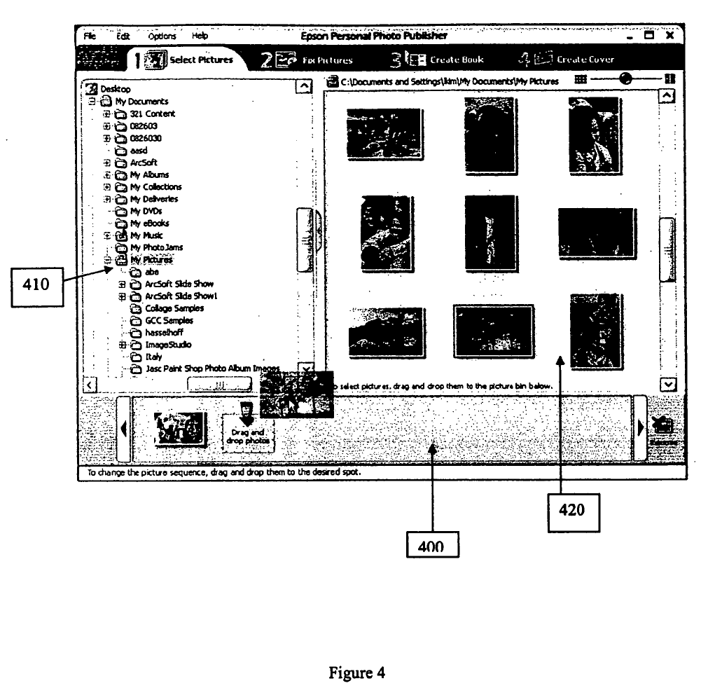

FIG. 5 illustrates a screen of a graphical user interface according to an embodiment of the present invention.

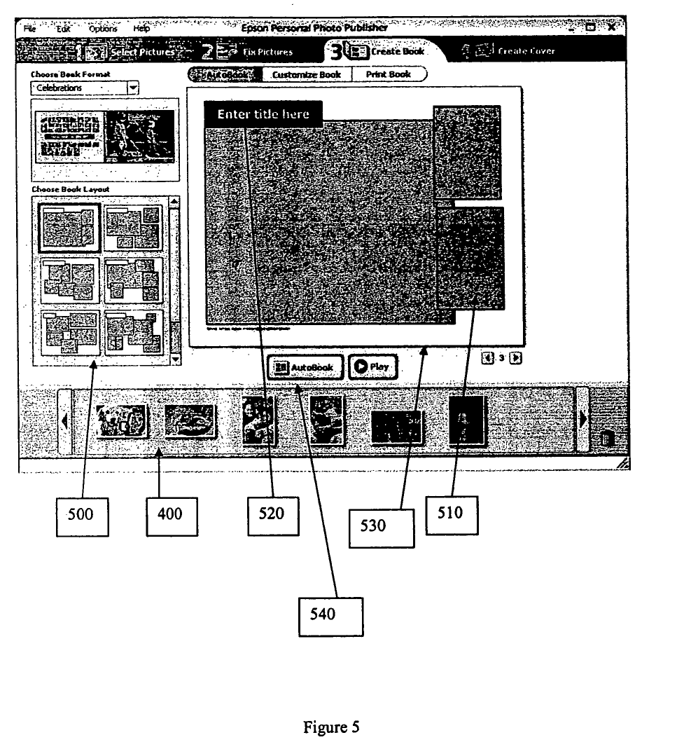

FIG. 6 illustrates a page layout template according to an embodiment of the present invention.

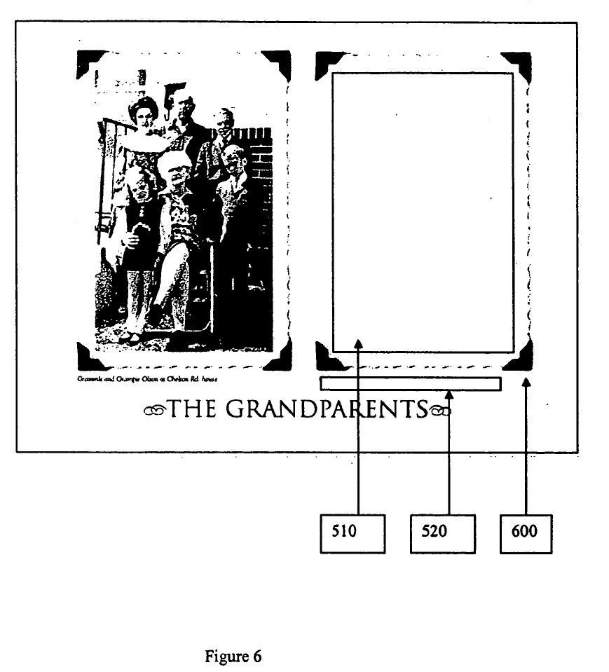

FIG. 7 illustrates a cover page layout template according to an embodiment of the present invention.

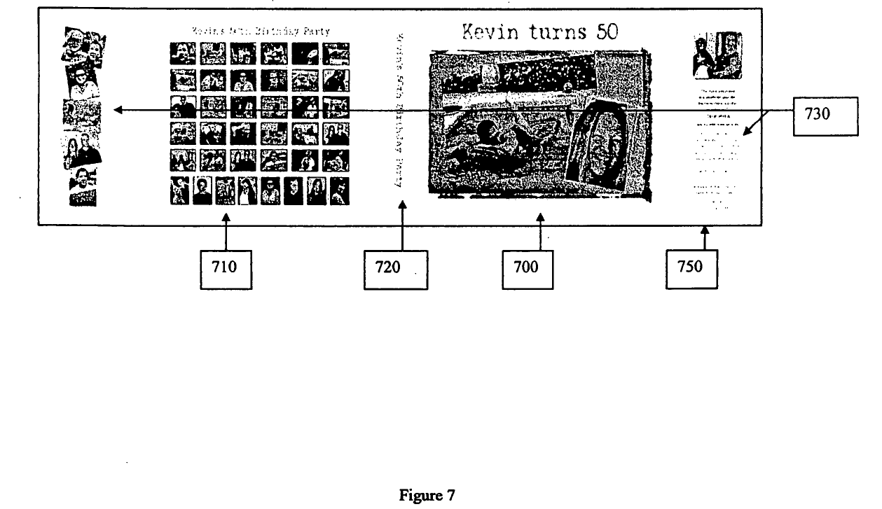

FIG. 8 illustrates a theme of layout templates according to an embodiment of the present invention.

FIG. 9 illustrates a theme of layout templates according to an embodiment of the present invention.

### DETAILED DESCRIPTION

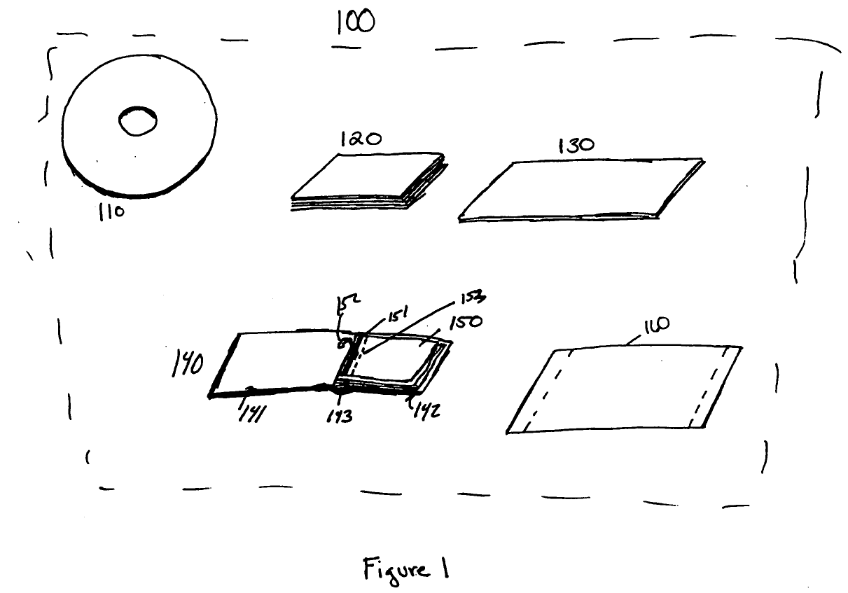

FIG. 1 depicts a kit 100 including elements to produce a personal photo book. In an embodiment of the present invention, the kit 100 includes a computer readable medium 110 having a computer-executable program code used for laying out the design of the personal photo book. The computer-readable medium 110 may be any kind of computer-readable medium known in the art such as a compact disc, a floppy disk, a zip disk, or a hard drive. The program code on the computer-readable medium 110 will hereinafter be referred to as the software.

The kit 100 may also include a plurality of photo printer pages 120 on which the layout of photos and text for use in the photo book may be printed. Preferably, the photo printer pages 120 may be used with conventional personal printers. Preferably, the photo printer pages 120 may be used with high quality personal photo printers. The kit may be designed to work with all inkjet and laser printers, such as printers available from EPSON such as printer model numbers R200/300, RX500/600, C86, and C4600. The photo printer pages 120 may be of standard dimension sizes such as 5″×7″, 8.5″×11″, or 8″×10″. Preferably, the kit 100 has a predetermined number of photo printer pages 120 such as 10 or 20 pages with at least two extra pages for use if one of the predetermined number of photo printer pages is destroyed, lost, or in some other way is not capable of being used as intended.

The kit 100 may also include a plurality of extra long photo printer pages 130 for use in printing the cover layout templates 750 to make a dust jacket for the book 140. Preferably, there are at least two extra long photo printer pages 130. Although only one may be used to make a cover for the personal photo book, a second may be included in case the first is destroyed, lost, or in some other way made incapable of being used as a cover for the personal photo book. The extra-long photo printer pages 130 are of dimensions such that they will completely cover the hard-bound book 140. Preferably, the extra-long photo printer pages 130 are of a length such that a portion of the extra long photo printer pages 130 may wrap around the edges of the front 141 and back 142 covers in a fashion like one would see in the covers of hard-bound novels. For instance, for a personal photo book that will incorporate the 8″×10″ photo printer pages 120, the extra-long photo printer pages 130 may be approximately 8.5″×28.73″. A personal photo book that may incorporate the 5″×7″ photo printer pages 120 may use an extra long photo printer page 130 with dimensions of 5.5″×20.87″. The kit may also include a clear polyester or polypropylene dust jacket 160 for the hard bound book 140. The dust jacket 160 preferably is substantially the same size as the extra long photo printer page 130, however it may also be longer or shorter depending on the embodiment. The dust jacket may also have properties that protect the cover from ultraviolet (UV) rays.

The kit may also include a hard-bound book 140 in which to place the photo printer pages 120 that have been printed with page layout templates 530 on them. The hard-bound book 140 preferably has a front cover 141 and a back cover 142 which are joined at a spine 143. The hard-bound book 140 preferably has a plurality of attachment pages 150 bound between the covers 141, 142 at the spine 143. The number of attachment pages 150 preferably is the same number of predetermined photo printer pages 120 included in the kit 100 (without considering the extra pages). The attachment pages 150 preferably all have an adhesive strip 151 that runs from the top of the page to the bottom page in a vertical fashion. In an embodiment of the present invention, the adhesive strip 151 is approximately ¼″ wide and located approximately ¼″ from the spine 143. Preferably, the adhesive strip 151 is initially covered by a release liner 152 which rests on top of the adhesive strip 151 to prevent the attachment pages 150 from adhering to one another or the covers 141, 142. In an embodiment of the present invention, the release liner 152 is approximately ½ wide. Each attachment page 150 may also have a perforation 153 that runs from the top of the page to the bottom of the page in a vertical fashion. The perforation 153 preferably is on the side of the adhesive strip 151 opposite the spine 143. The purpose of the perforation 153 is so that once the photo printer page 120 has been attached to the adhesive strip 151, the rest of the attachment page 150 may be removed so that only the photo printer page 120 and a small portion of the bound attachment page 150 remains. In an embodiment of the present invention, the perforation is located ¾″ from the spine 143.

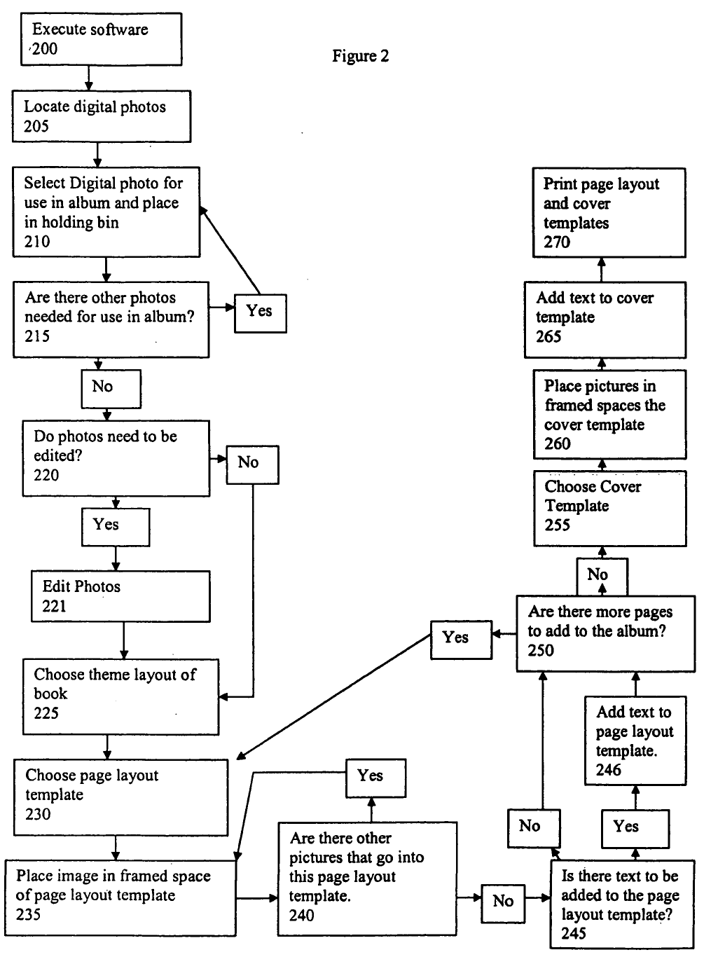

FIG. 2 illustrates the operation of the software to create the photo printer pages 120 printed with the page layout templates 530 and cover page templates 750. After the kit 100 has been opened, the user inserts the computer-readable medium 110 into a personal computer and executes the software 200. In an embodiment of the present invention, the software may be installed on the computer's hard drive or other memory. In another embodiment the software may be executed solely from the computer-readable medium. The software will cause a graphical user interface to appear on the monitor of the computer. The computer may then prompt the user to select images that the user may desire to place in the personal photo book. The user will then locate directories 410 containing the digital photos that she would like to use 205. The directories 410 may be a collection 420 of digital photos located on a hard drive, a web page, a compact disc, a floppy disk, or a peripheral device that is attached to the computer, such as a digital camera. The photos may have been taken with a digital camera or they may have been printed photos that have been scanned into a computer and made into a digital form.

After locating a directory containing pictures that the user would like to use, the user selects a digital photo and places 210 it in the holding bin 400. In an embodiment of the present invention, after the user has selected all the photos from a certain directory 410 that the user would like to use, the user may then select another directory 410 containing digital photos and repeat the same process 215. This process may repeat itself until the user has selected all the photos that the user may want to use in the personal photo book. If the a photo has been inadvertently placed in the holding bin 400, the photo may be removed from the holding bin 410. This can be accomplished in several different ways. In one embodiment the photo may be clicked upon once and then a removal icon, for instance a trash can icon which is on the graphical user interface, may be clicked to remove the icon. In another embodiment, the photo may be right clicked and then from a selection menu, the user may select a selection that would remove the photo from the photo bin 400. Other embodiments of removing the photo are well known to those skilled in the art.

The user may also now edit the photos if the photos need editing 220, 221. Several editing features may be available in the software. For instance, the picture may need to be rotated to be viewed correctly or cropped to enhance the subject of the photo. The user may also want to change the brightness or contrast of the image(s). The user may want to fix the condition commonly known as “Red Eye” wherein the flash from the camera causes the people in the picture to appear as if they have red eyes. Additionally, the user may want to sharpen the images or adjust the colors in the photos. There may also be a feature in the editing tools known as “Auto Enhance,” which performs one or several of the different functions listed above according to an algorithm designed to improve the quality of the picture. Other editing tools may include adjusting the tone of the photos such that images appear older than they actually are, such as making color photos appear black and white or in sepia tones. Other photo editing tools are well known in the art and are intended to be covered by the present invention.

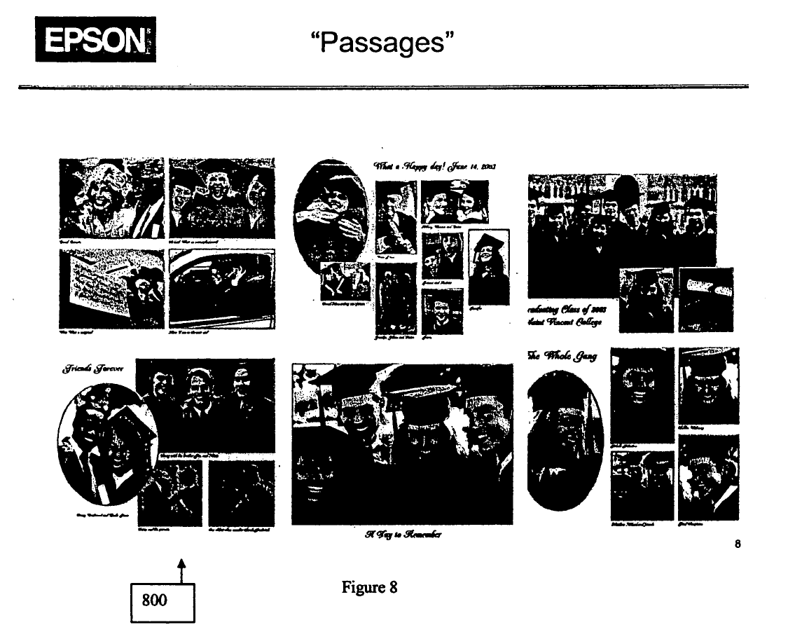

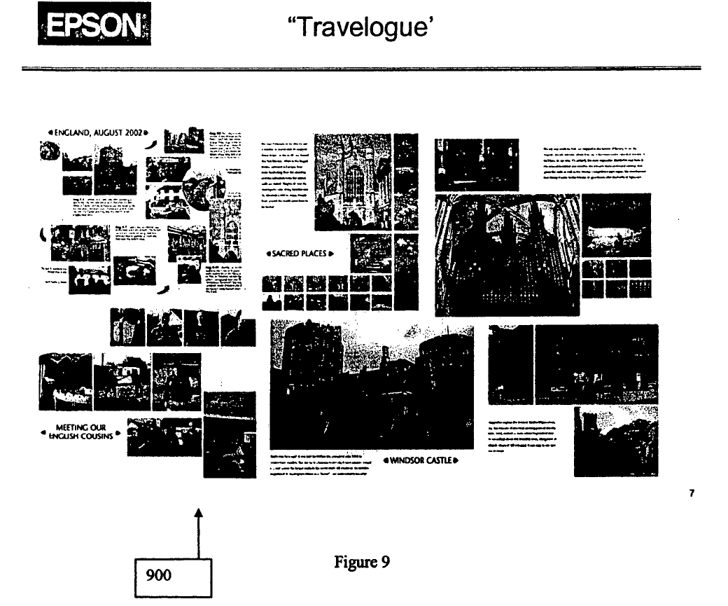

Now the user is ready to create the layout of the photo pages. The user begins by selecting a theme layout for the photo book 225. The theme layout is a collection 500 or set of digital page layout templates 530 that are categorized according to a certain theme. Digital page layout templates 530 are a predetermined way of laying out photos in spaces defined as image spaces 510, and the digital page layout templates 530 may also include predetermined areas 520 for text. By limiting the choices of the layout of the page to predetermined image space 510 and text areas 520 (ideally, the predetermined spaces 510 and areas 520 are chosen by a design professional), the photo book will look professionally created. The design professional may have determined that certain ways of laying out the pictures and text on a page may appear more congruent with another way of laying out photos and text on another page than with other layouts, and thus, the first two ways of laying out the photos (and possibly text) on a page are grouped together by a certain theme. For instance, a layout theme called “Passages” 800 may have layout templates 530 that are designed to portray a graduation, for example, as shown in FIG. 8. These templates 530 may have a small amount of text area 520 underneath an image space 510 to write, for instance, the name of the subject of the photo. Other themes such as “Travelogue” 900 may have templates 530 that are designed to show a vacation to England, such as in FIG. 9. The layout templates 530 of the “Travelogue” theme 900 may have larger text areas 520 to describe what the pictures are about or to describe certain events that are taking place in the photos.

Additionally, certain themes may have additional images already on the layout pages. For instance, say one would like to make a more formal photo album containing old family photos, the photo album being titled “The Way We Were.” In that layout theme, all of the corners surrounding the image spaces 520 may be bordered by black triangles 600 giving the impression that a photo is being held in by traditional photo corners like the ones that traditionally hold photos in non-computer produced scrapbooks. Other images that may be included on the digital page layout templates 530 may be images of balloons for instance to celebrate birthday themes or images of Christmas presents to celebrate Christmas themes. In another embodiment, these type of images may also be selected from a clipart type of folder and placed on the page, in much the same fashion as one would add clipart in a Microsoft Word® document.

Once the theme of the book has been selected 225, the user chooses the first digital page layout template 530 from a bank 506 of available page layout templates 530 for that them 230. In an embodiment of the present invention, there are at least as many distinct page layout templates 530 for a theme as there are number of pages in the book. In another embodiment of the present invention, each “theme” has ten distinct page layout templates. The user may now begin placing 235 the pictures in the image spaces 510 on the page layout template 530. Depending on the embodiment, there are several different ways that a user may select a picture to appear in a particular image space 510. For instance, the user may simply click a picture in the holding bin 400 once and then click an image space 510 in the page layout template 530. In another embodiment, the user may click-and-drag the image from the bin 400 into the image space 510. In another embodiment, the first image space 510 available may be highlighted by the software, and the user may click, or double-click, an image from the holding bin. In this embodiment, after an image space 510 has been filled, the next image space 510 may be highlighted by the software. Similarly, reversed processes of the above may be used to remove a picture from an image space 510, such as double-clicking on the photo in the image space 510 or dragging the image from the image space 510 to the holding bin 400. The software may also have a feature known as “Autobook” in which the user may choose for the software to automatically propagate the image spaces 510 of the page layout templates 530 with the photos that the user has selected and placed in the holding bin 410. In an embodiment of the invention, the Autobook feature may be implemented by clicking on an Autobook icon 540 located in the graphical user interface.

Once the image is inside the image space 510, it may need to be moved around inside the image space 510 so that the image space 510 shows the intended subject. For instance, most pictures are square or rectangular and some image spaces 510 may be oval and the oval may only show part of the rectangular or square picture. Therefore, the image may need to be moved around inside the image space 510 such that the oval clearly portrays the intended subject of that image space 510. This movement is most effectively done using the drag-and-hold movement well known to mouse users, however, use of the cursor keys may also be used as well.

Once the pictures have been added to the page layout template 530, the user may add text to the page layout if they so desire 245, 246. Preferably, there are predetermined text boxes already on the page layout template 530 so as to keep the design looking professional, however, other embodiments may allow a user to create the user's own text boxes using methods similar to the creation of text boxes in Microsoft Word® documents. Such text may identify the subject of the image space 510, or explain a little anecdote about the pictures.

The user continues to pick page layout templates 530, adding photos and text, until the user is either done adding photos or has run out of pages which may be added to the photo book (because the hard-bound book only has, for instance, twenty attachment pages).

Once the user has completed the number of page layout templates 530 intended to be added to the photo book, the user may now choose 255 a cover template 750, from a collection of templates from which to make covers for the hard bound book. Preferably, there will be at least three distinct cover templates 750 included in the software. Each cover template 750 preferably has distinct layout areas for the front cover 700, the back cover 710, the spine 720, and two flap areas 730—one that wraps around the front cover and one that wraps around the back cover.

The front cover layout area 700 preferably has image spaces 510 for one to five photos and a predetermined text area 520 that allows a user to add a title to the photo book. The back cover layout area 710 preferably has image spaces 510 that are automatically populated (by the software) with thumbnail photos of all of the photos contained in the photo book, however, the back cover area 710 may have a few image spaces 510 that are not automatically populated or it may have no image spaces 510 at all. Additionally, the back cover layout area 710 may have a text area 520 for the title of the photo book and a text area 520 for a description of the general theme of the photo book (similar to the text on the back of a paperback novel), or it may only have one or none of these text areas 520. The spine layout area 720 of the book preferably has a text area 520 for a title of the book, situated in such a fashion so that one may read the title of the book in the same fashion that one would read the title on the spine of any other book. The two flap layout areas 730 may have image spaces for photos 510 and text areas 520, or they may have only one or none of these. The cover layout templates 750 may also be associated with a theme and thus may incorporate certain aspects of that theme such as black triangles 600 formed at the corners of image space 510 to appear as traditional photo corners, and other images such as balloons to celebrate birthday themes. The user may add pictures 260 and text 265 to the cover page template 750 as the user so desires.

Once all of the page layout templates 530 and the cover layout template 750 have been completed, the user may now print the pages 270 to make printed page layout templates 530 and a printed cover layout template 750. The user is now ready to add the printed page layout templates 530 to the hard bound photo book.

The user may now open 300 the hard-bound book 140 provided in the kit 100. The first attachment page 150 will be present. The user may line up 320 the printed page layout template 530 that the user would like to user with attachment page 150, such that at least three of the edges of the printed page layout template 530 match those of the attachment page 150. The user may then remove 310 the release liner 152 to expose the adhesive strip 151. The printed page layout template 530 may then be pressed down along the adhesive strip 151 to ensure that the printed page layout template 530 is secured inside the hard-bound book 140. After the printed template 530 is secure, the rest of the attachment page 150 may be separated 330 from the part of the attachment page 150 which is still bound within the hard-bound book 140 at the perforation 153. The rest of the printed page layout templates 530 should be secured 335 in a like manner until all the printed page layout pages have been secured within the hard-bound book 140, or there are no more attachment pages with which to secure the printed templates 530. Now the printed cover page template 750 may be wrapped 340 around the book and the flap layout areas (cover flaps) wrapped around the edges of the covers in a fashion similar to the covers of most hard-bound novels. After the printed cover page template 750 has been wrapped around the book, the dusk jacket 160, may also be wrapped around the hard-bound book 140 to further protect the book 140 and the printed cover page template.

While the description above refers to a particular embodiment of the present invention, it will be understood that many modifications may be made without departing from the spirit thereof. The accompanying claims are intended to cover such modifications as would fall within the true scope and spirit of the present invention. For instance, although the present invention has been identified with certain steps as one coming before another, it is readily understood that these steps may be taken out of order without departing from the invention. For instance, in the present application, it has been stated that the step of selecting 210 photos relevant to photo album is taken before the user chooses a layout theme 225. However, the converse can be true as well without departing from the spirit of this invention. Additionally, one may remove 310 the release liner 152 before squaring 320 the printed page layout template 530 with attachment page 150, in contrast to the method otherwise presented herein without departing from the spirit of this invention. The presently disclosed embodiments are therefore to be considered in all respects as illustrative and not restrictive, the scope of the invention being indicated by the appended claims, rather than the forgoing description, and all changes that come within the meaning and range of equivalency of the claims are therefore intended to be embraced therein.

What is claimed is:

1. A kit for producing a photo book using a personal computer, comprising:
a computer-readable medium having encoded thereon a computer-readable program code which when executed causes a computer to place a plurality of digital photos into a plurality of digital page-layout templates in response to a first input and prints at least one of the digital page-layout templates on a personal printer in response to a second input;
a plurality of photo printer pages on which to print the at least one of the digital page-layout templates; and
a book having a top cover, a bottom cover, a spine, and a plurality of attachment pages between the top cover and the bottom cover and the plurality of attachment pages are bound together at a bound edge, the bound edge being the edge closest to the spine,
wherein each of the plurality of attachment pages have an adhesive strip extending vertically near the bound edge and a perforation extending vertically near the adhesive strip, on a side of the adhesive strip opposite the spine, the attachment pages being used to secure a printed digital page layout template in the book.

2. The kit of claim 1, wherein at least one of the plurality of photo printer pages is an oversized book cover page, the oversized book cover page being of a length that is greater than the length of the book from an edge of the bottom cover to an edge of the top cover.

3. The kit of claim 1, wherein, when executed, the computer-readable program code further causes the computer to place text on the plurality of digital page layout templates in response to an input.

4. The kit of claim 1, wherein, when executed, the computer-readable program code further causes the computer to generate at least four distinct digital page layout template sets, each set including a plurality of digital page layout templates grouped together based on a theme.

5. The kit of claim 1, further including a removable release liner over the adhesive strip.

6. The kit of claim 1, wherein the perforation is located ⅛″ from the adhesive strip.

7. The kit of claim 1, wherein the release liner is ½″ wide.

8. The kit of claim 2, wherein, when executed, the computer-readable program code further causes the computer to place a title and an image on a digital representation of a first half of the oversized book cover page and a thumbnail set of the plurality of digital photos on a digital representation of a second half of the oversized book cover page in response to an input.

9. The kit of claim 1, wherein, when executed, the computer-readable program code further causes the computer to perform an editing function on at least one of the plurality of digital photos in response to an input.

10. The kit of claim 1, wherein the book is a hard-bound book.

11. A book comprising:
a front cover joined to a back cover at a spine, and a plurality of attachment pages being bound inside the book at the spine,
wherein the plurality of attachment pages have an adhesive strip running vertically near the bound edge of the attachment page and a perforation running vertically near the adhesive strip such that if the attachment page is torn at the perforation, the adhesive strip is still bound inside the book.

12. The book of claim 11, wherein the adhesive strip has a top edge and a bottom edge such that the top edge is located approximately at a top edge of the attachment page and the bottom edge is located approximately at a bottom edge of the attachment page.

13. The book of claim 11, wherein the adhesive strip is located approximately ¼″ from the spine.

14. The book of claim 11, wherein the adhesive strip is approximately ¼″ in width.

15. The book of claim 11, further including a removable release liner on a surface of the adhesive strip, said removable release liner completely covering the adhesive strip.

16. The book of claim 15, wherein the release liner is approximately ½″ in width.

17. The book of claim 11, wherein the perforation is located approximately ¾″ from the spine.

18. The book of claim 11, wherein the perforation as a beginning perforation and a terminating perforation and the beginning perforation is located approximately at a top edge of the attachment page and the terminating perforation is located approximately at the bottom edge of the attachment page.

19. The book of claim 11, wherein the book is a hard-bound book

20. A kit for producing a photo book using a personal computer, comprising:
a plurality of photo printer pages on which to print the at least one of the digital page-layout templates; and
a book having a top cover, a bottom cover, a spine, and a plurality of attachment pages between the top cover and the bottom cover and the plurality of attachment pages are bound together at a bound edge, the bound edge being the edge closest to the spine,
wherein each of the plurality of attachment pages have an adhesive strip extending vertically near the bound edge and a perforation extending vertically near the adhesive strip, on a side of the adhesive strip opposite the spine, the attachment pages being used to secure a printed digital page layout template in the book.

21. The kit of claim 20, wherein at least one of the plurality of photo printer pages is an oversized book cover page, the oversized book cover page being of a length that is greater than the length of the book from an edge of the bottom cover to an edge of the top cover.

22. The kit of claim 20, further including a removable release liner over the adhesive strip.

23. The kit of claim 20, wherein the perforation is located ⅛″ from the adhesive strip.

24. The kit of claim 22, wherein the release liner is ½″ wide.

25. The kit of claim 20, wherein the book is a hard-bound book.

26. A method of producing a personal photo book comprising:
printing a plurality of layout pages on a personal printer;
securing the plurality of layout pages inside a book, said book having a top cover, a bottom cover, a spine, and a plurality of attachment pages between the top cover and the bottom cover and the plurality of attachment pages are bound together at a bound edge, the bound edge being the edge closest to the spine, and each of the plurality of attachment pages has an adhesive strip extending vertically near the bound edge and a perforation extending vertically near the adhesive strip, on a side of the adhesive strip opposite the spine, the attachment pages being used to secure the plurality of layout pages in the book and wherein the securing utilizes the adhesive strip; and
removing a portion of the plurality of attachment pages at the perforation.

27. The method of claim 26, wherein the book includes a removable release liner over the adhesive strip and the method further includes removing the release liner before securing the plurality of layout pages to the plurality of attachment pages.

28. The method of claim 26, wherein the perforation is located ⅛″ from the adhesive strip.

29. The method of claim 26, wherein the adhesive strip is ¼″ wide.

30. The method of claim 26, wherein the book is a hard-bound book.

31. The method of claim 26, wherein the personal printer is an ink-jet printer.

32. The method of claim 26, wherein the personal printer is a color laser-jet printer.

33. The kit of claim 1 further including a dust jacket

34. The kit of claim 33, wherein the dust jacket provides protection against ultraviolet rays.

35. The kit of claim 20 further including a dust jacket

36. The kit of claim 35, wherein the dust jacket provides protection against ultraviolet rays.
